(19) United States
(12) Patent Application Publication
(10) Pub. No.: US 2019/0243133 A1
(43) Pub. Date: Aug. 8, 2019

(54) BACKLIGHT MODULE AND HEAD-UP DISPLAY

(71) Applicant: Chunghwa Picture Tubes, LTD., Taoyuan City (TW)

(72) Inventors: Chia-Cheng Liao, Taichung City (TW); Jan-Tian Lian, Keelung City (TW)

(73) Assignee: Chunghwa Picture Tubes, LTD., Taoyuan City (TW)

(21) Appl. No.: 15/970,903

(22) Filed: May 4, 2018

(30) Foreign Application Priority Data
Feb. 8, 2018 (CN) 201810125772.6

(51) Int. Cl. G02B 27/01; G09G 3/34; B60K 35/00

(52) U.S. Cl. CPC G02B 27/0101; G09G 3/342; B60K 35/00; G02B 2027/0118; G09G 2360/147; G09G 2360/144; G01C 21/3632; G09G 2320/0626; G09G 2320/066; G09G 2330/021; B60K 2350/2039; B60K 2350/2034; B60K 2350/2069; G09G 2380/10

(57) ABSTRACT

A backlight module and a head-up display (HUD) are provided. The backlight module includes a bottom plate and light-emitting sources arranged in an array on a surface of the bottom plate facing a transparent device to provide a light beam. A distance between the bottom plate and the transparent device in a direction of an optical axis is determined according to a total illuminance distribution of the light beam projected on the transparent device and locations where the light-emitting sources are arranged on the surface. The HUD includes a projection unit having a display panel and the above-mentioned backlight module and an optical sheet for reflecting the image beam to a user's eyes. The light beam penetrates the display panel to form the image beam. The transparent device of the backlight module is a display panel or a diffusion sheet located between the display panel and the light-emitting sources.

### CROSS-REFERENCE TO RELATED APPLICATION

This application claims the priority benefit of China application serial no. 201810125772.6, filed on Feb. 8, 2018. The entirety of the above-mentioned patent application is hereby incorporated by reference herein and made a part of this specification.

### BACKGROUND

### Technical Field

The disclosure relates to a backlight module and a head-up display (HUD).

### Description of Related Art

As the demand for electronic parts for transportation has increased year by year, various display apparatuses used for transportation have been successively developed. Conventional display apparatuses are often mounted on dashboards of vehicles. When a driver heads down and looks at the display apparatus mounted on the dashboard, the concern about driving safety often arises, and therefore a HUD capable of projecting images on the windshield has been extensively used in automobiles. The meaning of “head up” indicates that the user can see the important message he or she needs in no need of moving his or her head down.

However, the conventional HUD often encounters the issue of poor contrast. If the ambient light is excessively strong, the visibility or readability of the displayed image is reduced, so that the driver cannot observe clear image projected to the front windshield, casting doubts on transportation safety. According to the related art, said technical issue may be resolved by increasing the brightness of the backlight source; nevertheless, the light source with high intensity requires additional energy, which leads to the increase in the operational costs and the concern about the dissipation of the backlight source.

### SUMMARY

In view of the above, the disclosure provides a backlight module and a HUD with favorable display effects, the demands for low power consumption, compactness, and high brightness can be satisfied, and the issue of display contrast and sunlight readability can be solved.

According to an embodiment, a backlight module that provides a light beam to irradiate a transparent device is provided, and the backlight module includes a bottom plate and a plurality of light-emitting sources. The bottom plate is disposed below the transparent device. The light-emitting sources are arranged in an array on a surface of the bottom plate facing the transparent device and configured to provide the light beam. A distance L between the bottom plate and the transparent device in a direction of an optical axis is determined according to a total illuminance distribution of the light beam projected on the transparent device and locations where the light-emitting sources are arranged on the surface.

According to an embodiment, the distance L is determined according to the following equation:

$$\frac{{\partial }^{ 2}}{\partial {x}^{2}} {E}_{BLU} ( x , y , z ) = 0 , and \frac{{\partial }^{ 2}}{\partial {y}^{2}} {E}_{BLU} ( x , y , z ) = 0$$

Here, E_{BLU}(x,y,z) is the total illuminance distribution, a geometric center of the light-emitting sources on the surface of the bottom plate or a geometric center of an arrangement unit of the light-emitting sources is a coordinate origin, z is a coordinate in a first direction, x is a coordinate in a second direction, and y is a coordinate in a third direction, wherein the first direction is perpendicular to the surface of the bottom plate, and the second direction and the third direction are parallel to the surface of the bottom plate and are perpendicular to each other.

According to an embodiment, the light-emitting sources on the surface of the bottom plate are arranged in a square array, and a relationship between a minimum distance d between adjacent light-emitting sources of the light-emitting sources and the distance L between the bottom plate and the transparent device in the direction of the optical axis satisfies the following equation:

$$d = \frac{2 \cdot L}{{( m + 2 )}^{0.5}} ,$$

wherein m is a directive order of the light-emitting sources.

According to an embodiment, the light-emitting sources on the surface of the bottom plate are arranged in a square array, and a relationship between a minimum distance d between adjacent light-emitting sources of the light-emitting sources and the distance L between the bottom plate and the transparent device in the direction of the optical axis satisfies the following equation:

$$d = \frac{2}{\sqrt{3}} L$$

Here, each of the light-emitting sources is a Lambertian light source.

According to an embodiment, the backlight module further includes a diffusion sheet which is the transparent device.

According to an embodiment, the transparent device is a display panel.

In an embodiment, the HUD includes a display panel, a display module, and an optical sheet. The display panel is disposed on a transmission path of a light beam and configured to display an image, and the light beam penetrates the display panel to form the image beam. The backlight module is configured to provide a light beam to irradiate the display panel and includes a bottom plate, a diffusion sheet, and a plurality of light-emitting sources. The bottom plate is disposed below the display panel. The diffusion sheet is disposed on the transmission path of the light beam and located between the bottom plate and the display panel. The light-emitting sources are arranged in an array on a surface of the bottom plate and configured to emit the light beam. Here, a distance L between the bottom plate and the diffusion sheet in a direction of an optical axis is determined according to a total illuminance distribution of the light beam projected on the diffusion sheet and locations where the light-emitting sources are arranged on the surface of the bottom plate. The optical sheet is disposed on a transmission path of the image beam, and the image beam is reflected by the optical sheet to a user's eyes.

According to an embodiment, the distance L is determined according to the following equation:

$$\frac{{\partial }^{ 2}}{\partial {x}^{2}} {E}_{BLU} ( x , y , z ) = 0 , and \frac{{\partial }^{ 2}}{\partial {y}^{2}} {E}_{BLU} ( x , y , z ) = 0$$

Here, E_{BLU}(x, y, z) is the total illuminance distribution, a geometric center of the light-emitting sources on the surface of the bottom plate or a geometric center of an arrangement unit of the light-emitting sources is a coordinate origin, z is a coordinate in a first direction, x is a coordinate in a second direction, and y is a coordinate in a third direction, wherein the first direction is perpendicular to the surface of the bottom plate, and the second direction and the third direction are parallel to the surface of the bottom plate and are perpendicular to each other.

According to an embodiment, the light-emitting sources are arranged in a square array, and a relationship between a minimum distance d between adjacent light-emitting sources of the light-emitting sources and the distance L between the bottom plate and the diffusion sheet in the direction of the optical axis satisfies the following equation:

$$d = \frac{2 \cdot L}{{( m + 2 )}^{0.5}} ,$$

wherein m is a directive order of the light-emitting sources.

According to an embodiment, the light-emitting sources are arranged in a square array, and a relationship between a minimum distance d between adjacent light-emitting sources of the light-emitting sources and the distance L between the bottom plate and the diffusion sheet in the direction of the optical axis satisfies the following equation:

$$d = \frac{2}{\sqrt{3}} L$$

Here, each of the light-emitting sources is a Lambertian light source.

According to an embodiment, the HUD further includes a dimming device and a backlight brightness control circuit. The dimming device is configured to receive image data, divide the image data into a plurality of image blocks corresponding to locations or the number of the light-emitting sources, and generate a backlight brightness setting value of the light-emitting sources according to an image feature of each of the image blocks. The backlight brightness control circuit is coupled to the light-emitting sources and the dimming device and receives the backlight brightness setting value from the dimming device for respectively adjusting light intensity of each of the light-emitting sources according to the backlight brightness setting value.

According to an embodiment, the dimming device determines the backlight brightness setting value of a corresponding light-emitting source of the light-emitting sources according to a brightness value of pixels in each of the image blocks.

According to an embodiment, the HUD further includes a light sensor configured to detect environment and generate an ambient light feature. The light sensor is coupled to the backlight brightness control circuit. Here, the backlight brightness control circuit adjusts the light intensity of each of the light-emitting devices according to the ambient light feature generated by the light sensor.

According to an embodiment, a material of the optical sheet includes glass, a front windshield, optical film glass, or metalized film glass.

In an embodiment, the HUD includes a display panel, a display module, and an optical sheet. The display panel is disposed on a transmission path of a light beam and configured to display an image, and the light beam penetrates the display panel to form the image beam. The backlight module is configured to provide a light beam to irradiate the display panel and includes a bottom plate and a plurality of light-emitting sources. The bottom plate is disposed below the display panel. The light-emitting sources are arranged in an array on a surface of the bottom plate and configured to emit the light beam. Here, a distance between the bottom plate and the display panel in a direction of an optical axis is determined according to a total illuminance distribution of the light beam projected on the display panel and locations where the light-emitting sources are arranged on the surface of the bottom plate. The optical sheet is disposed on a transmission path of the image beam, and the image beam is reflected by the optical sheet to a user's eyes.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1 is a schematic side view illustrating a HUD according to an embodiment of the invention.

FIG. 2 is a schematic side view illustrating a backlight module according to an embodiment of the invention.

FIG. 3 is a schematic side view illustrating a HUD according to an embodiment of the invention.

FIG. 4 is a schematic view illustrating an illuminance distribution of a plurality of light-emitting sources according to an embodiment of the invention.

FIG. 5A to FIG. 5C are schematic views illustrating an illuminance distribution of light-emitting sources arranged in a square array on different conditions.

FIG. 6 is a schematic block view illustrating a projection unit according to an embodiment of the invention.

FIG. 7 is a schematic view illustrating image data according to an embodiment of the invention.

FIG. 8 illustrates a distribution of backlight brightness setting values of a backlight module according to an embodiment of the invention.

FIG. 9 illustrates a backlight illuminance distribution of a backlight module according to an embodiment of the invention.

FIG. 10 is a schematic view illustrating compensation results of image data of a display panel according to an embodiment of the invention.

FIG. 11 is a schematic side view illustrating a HUD according to an embodiment of the invention.

### DETAILED DESCRIPTION OF THE EMBODIMENTS

Reference will now be made in detail to the exemplary embodiments of the invention, examples of which are illustrated in accompanying figures. Wherever possible, identical reference numbers are used in figures and descriptions to refer to identical or similar parts.

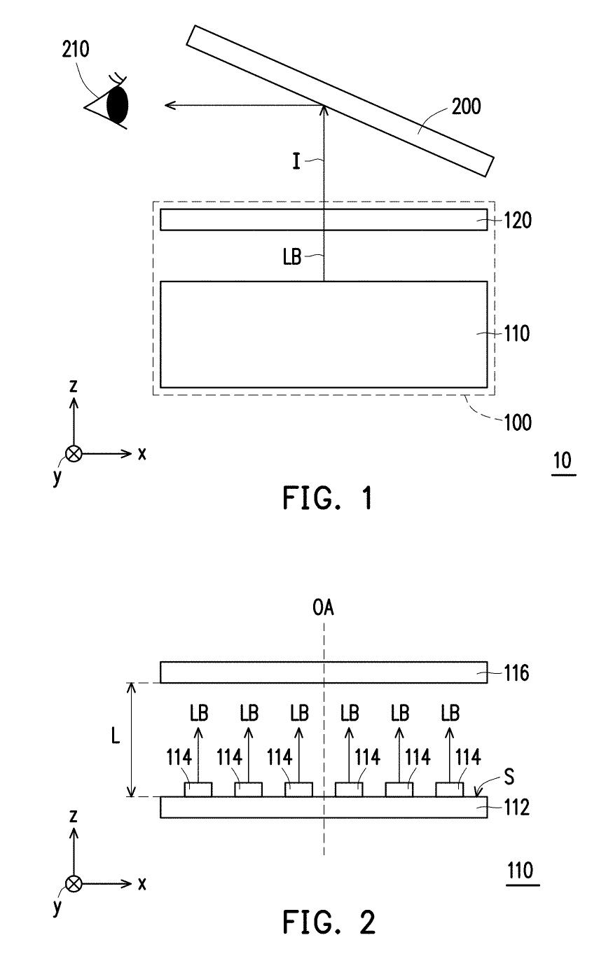

FIG. 1 is a schematic side view illustrating a HUD according to an embodiment of the invention. For clarity of expression, the drawings are marked with an x-y-z rectangular coordinate system in which the direction x, the direction y, and the direction z are perpendicular to each other.

With reference to FIG. 1, the HUD 10 includes a projection unit 100 and an optical sheet 200. The projection unit 100 includes a backlight module 110 and a display panel 120. The backlight module 110 provides a light beam LB to irradiate the display panel 120. The display panel 120 is configured to display an image and disposed on a transmission path of the light beam LB. The light beam LB penetrates the display panel 120 to generate an image beam I. The projection unit 100 outputs the image beam I. The optical sheet 200 is disposed on a transmission path of the image beam I and reflects the image beam I to eyes 210 of a user, so as to allow the user to see the image.

In the present embodiment, the backlight module 110 is configured to provide a uniform planar light source and may be a direct-type backlight module.

According to the present embodiment, the display panel 120 may be a non-self-luminous display panel, e.g., various kinds of liquid crystal display (LCD) panels including a twisted nematic (TN) LCD panel, a super twisted nematic (STN) LCD panel, a vertical alignment (VA) LCD panel, an in-plane switching (IPS) LCD panel, a fringe field switching (FFS) LCD panel, or any other appropriate display panel. A material of the optical sheet 200 includes glass, a front windshield, optical film glass, metalized film glass, etc.

FIG. 2 is a schematic side view illustrating a backlight module according to an embodiment of the invention. With reference to FIG. 2, the backlight module 110 includes a bottom plate 112 and a plurality of light-emitting sources 114. The backlight module 110 provides a light beam to irradiate a transparent device 116. The bottom plate 112 is disposed below the transparent device 116. The light-emitting sources 114 are arranged in an array on a surface S of the bottom plate 112 facing the transparent device 116 for emitting the light beam LB. The number of the light-emitting sources 114 shown in the drawings is merely exemplary and should not be construed as a limitation in the disclosure.

In the present embodiment, the light beam LB is transmitted from the light-emitting sources 114 to the transparent device 116 and penetrates the transparent device 116, so as to act as a light source, e.g., an irradiation light source or an image light source. A distance L between the bottom plate 112 and the transparent device 116 in a direction of an optical axis OA is determined according to a total illuminance distribution of the light beam projected on the transparent device 116 by the light-emitting sources 114 and locations (e.g., arrangement pitch or arrangement pattern) where the light-emitting sources 114 are arranged on the surface S. Specifically, through adjusting the distance L and the locations where the light-emitting devices 114 are arranged, the uniformity of brightness of the light beam LB projected on the transparent device 116 may be optimized. Hence, the backlight module 110 provided in the present embodiment can provide the irradiation light source with the uniform brightness in no need of additional optical lenses nor any complicated light uniformizing device, so as to satisfy the requirement for compactness and high brightness.

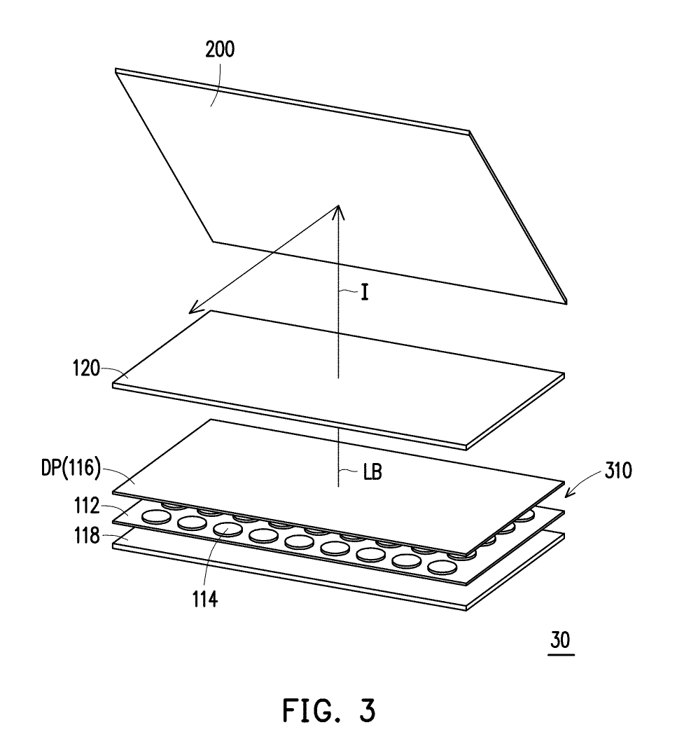

FIG. 3 is a schematic side view illustrating a HUD according to an embodiment of the invention. A diffusion sheet DP in the backlight module 310 of the HUD 30 is the transparent device 116 depicted in FIG. 2 and also includes a heat dissipation sheet 118. In the present embodiment, the backlight module 310 enhances the uniformity with use of the diffusion sheet DP, so as to provide the planar light source with uniformity for irradiating the display panel 120 depicted in FIG. 1 and generate the image beam I.

How to implement the backlight module is described in the embodiments below.

In the present embodiment, the light sources 114 are, for instance, light-emitting diodes (LED), and a normal distribution of light intensity of each of the light sources 114 is represented by the following equation (1):

I_{LED}(θ)=I₀·cos^{int}(θ) (1)

Here, I₀ is the unit light intensity, and

$$m = \frac{- ln 2}{ln ( cos {θ}_{1 / 2} )}$$

is a directive order of the light source. The larger the value, the higher the directivity of the LED. When m=1, the light source is represented as a Lambertian light source.

The illuminance distribution E_{LED} (x,y,z) of one single light-emitting source 114 on the diffusion sheet DP may be derived from the equation (1) and expressed by the following equation (2):

$${E}_{LED} ( x , y , z ) = {I}_{0} \cdot \frac{{z}^{m}}{{[ {( x - X 0 )}^{2} + {( y - Y 0 )}^{2} + {z}^{2} ]}^{\frac{m + 2}{2}}} \qquad ( 2 )$$

Here, a geometric center of the light-emitting sources 114 on the surface S or a geometric center of one arrangement unit of the light-emitting sources 114 arranged in an array (e.g., square units shown in FIG. 3) may be selected as a coordinate origin, wherein the light-emitting sources 114 are arranged in an array formed by arrangement units on the surface S. Here, the geometric center of the light-emitting sources 114 on the surface S is selected as the coordinate origin, the direction z is perpendicular to the surface S and is the same as the direction of the optical axis OA, the directions x and y are parallel to the surface S and perpendicular to each other, x, y, and z are coordinates respectively in the directions x, y, and z, and each of X₀ and Y₀ is a coordinate of one single light source 114 on the surface S.

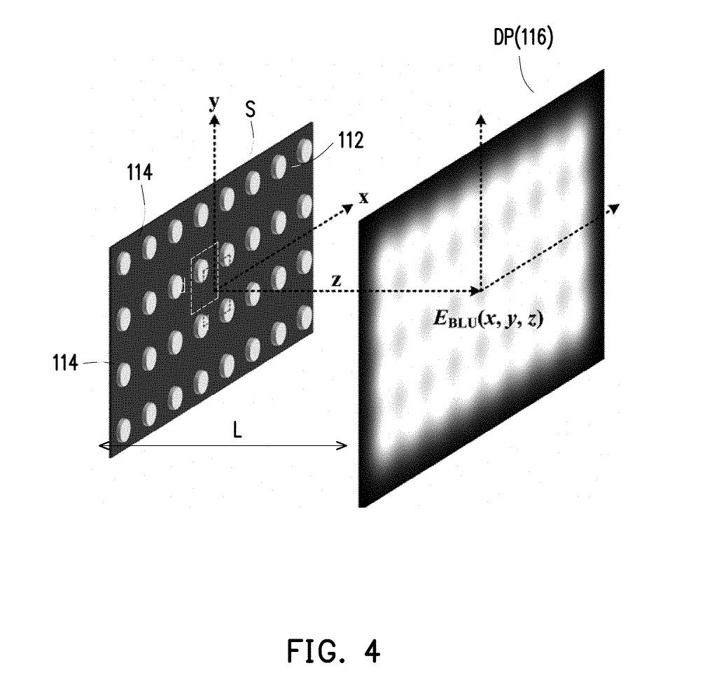

FIG. 4 is a schematic view illustrating an illuminance distribution of a plurality of light-emitting sources according to an embodiment of the invention. With reference to FIG. 3 and FIG. 4, according to the principle of superposition, the total illuminance distribution E_{BLU} (x,y,z) of the light-emitting sources 114 (assuming the number of the light-emitting sources 114 is n) in the backlight module 310 is expressed as the following equation (3):

$${E}_{BLU} ( x , y , z ) = {\sum }_{i = 1}^{n} {E}_{i , LED} ( x , y , z ) \qquad ( 3 )$$

An optimization algorithm may then be applied to solve the equation (3) to obtain the condition that satisfies the optimization of the brightness uniformity. For instance, an observation point on the surface S may be selected to make the second partial derivative of the equation (3). When the following equation (4) is satisfied, the optimized condition of the backlight brightness uniformity may be obtained. Note that the algorithm for calculating the optimized condition of the backlight brightness uniformity is not limited herein.

$$\frac{{\partial }^{ 2}}{\partial {x}^{2}} {E}_{BLU} ( x , y , z ) = 0 , and \frac{{\partial }^{ 2}}{\partial {y}^{2}} {E}_{BLU} ( x , y , z ) = 0 \qquad ( 4 )$$

In the present embodiment, the light-emitting sources 114 on the surface S are arranged in a square array (i.e., the arrangement units are shaped as squares). The side length of the smallest square arrangement unit is d, i.e., the shortest distance between the adjacent light-emitting sources 114. Hence, the equation (4) may be simplified as equation (5). When the relationship between the shortest distance d between the adjacent light-emitting sources 114 and the distance L between the bottom plate 112 and the diffusion sheet DP in the direction of the optical axis OA satisfies the equation (5) below, the backlight brightness uniformity of the backlight module 310 is optimized:

$${d}_{opt} = \frac{2 \cdot L}{{( m + 2 )}^{0.5}} \qquad ( 5 )$$

In particular, if each of the light-emitting sources 114 is a Lambertian light source, it indicated that the directive order m=1. When the equation (6) below is satisfied, the backlight module 110 obtains the condition that satisfies the optimization of the backlight brightness uniformity:

$${d}_{opt} = \frac{2}{\sqrt{3}} L \qquad ( 6 )$$

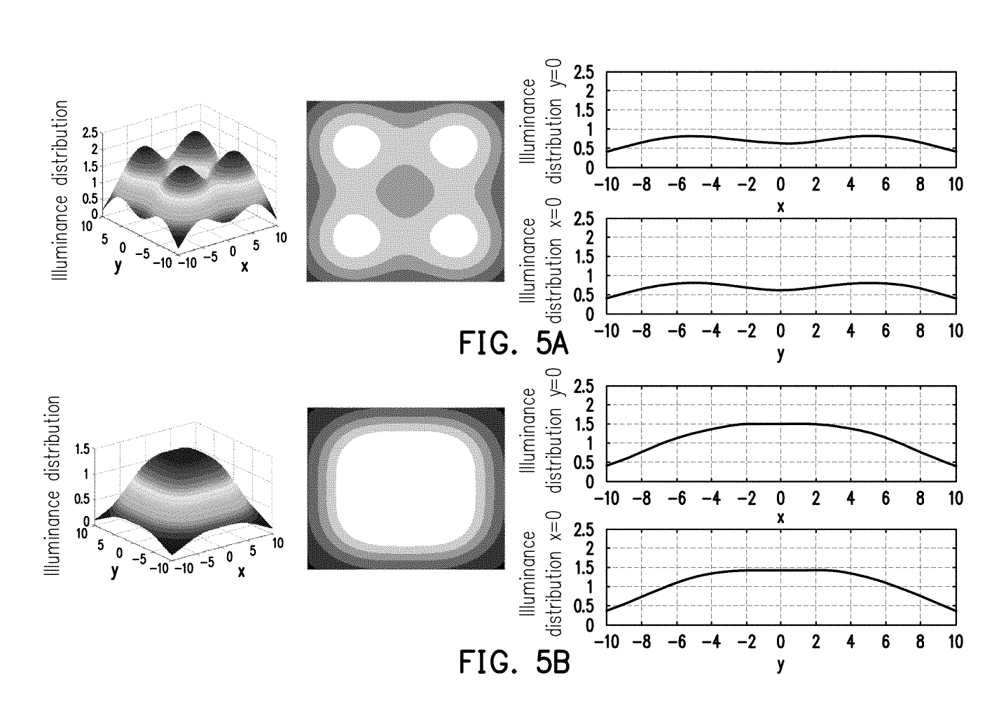

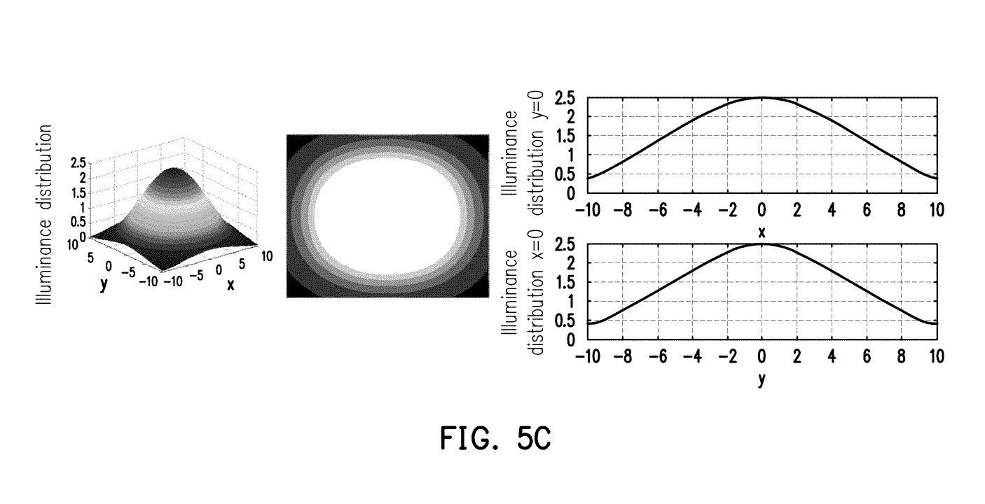

FIG. 5A to FIG. 5C are schematic views illustrating an illuminance distribution of light-emitting sources arranged in a square array on different conditions. On the condition that the distance L remains unchanged, four light-emitting sources 114 are arranged in form of three kinds of squares with different side lengths d, and the illumination distribution on the diffusion sheet DP is shown in FIG. 5A to FIG. 5C. A three-dimensional view of the illumination distribution, a two-dimensional view of the illumination distribution, and a cross-sectional view of the illumination along the direction x and the direction y on the surface of the diffusion sheet DP are shown from left to right. In the present embodiment, the light-emitting sources 114 are Lambertian light sources. FIG. 5A shows the results obtained when the side length d of the square units is greater than the optimized side length dₒₚₜ. FIG. 5B shows the results obtained when the side length d of the square units is equal to the optimized side length dₒₚₜ (i.e., satisfying the equation (6)). FIG. 5C shows the results obtained when the side length d of the square units is less than the optimized side length dₒₚₜ. From the above results, it can be seen that the backlight brightness uniformity may be controlled by determining the distance L and the locations where the light-emitting sources 114 are arranged on the surface S. Besides, if the equation (6) is satisfied, the backlight brightness uniformity is high, and the thin diffusion sheet DP is applied to reinforce the uniformity. Accordingly, the HUD 30 does not encounter the difficulty heat dissipation resulting from stacking the heating sources due to the overly crowded light-emitting sources 114. Moreover, the backlight module 310 has the simple structure and can satisfy the requirement for compactness.

Note that the light-emitting sources 114 in other embodiments may be arranged in a triangular, rhombus, hexagonal periodic pattern, and so on, which should not be construed as a limitation in the disclosure.

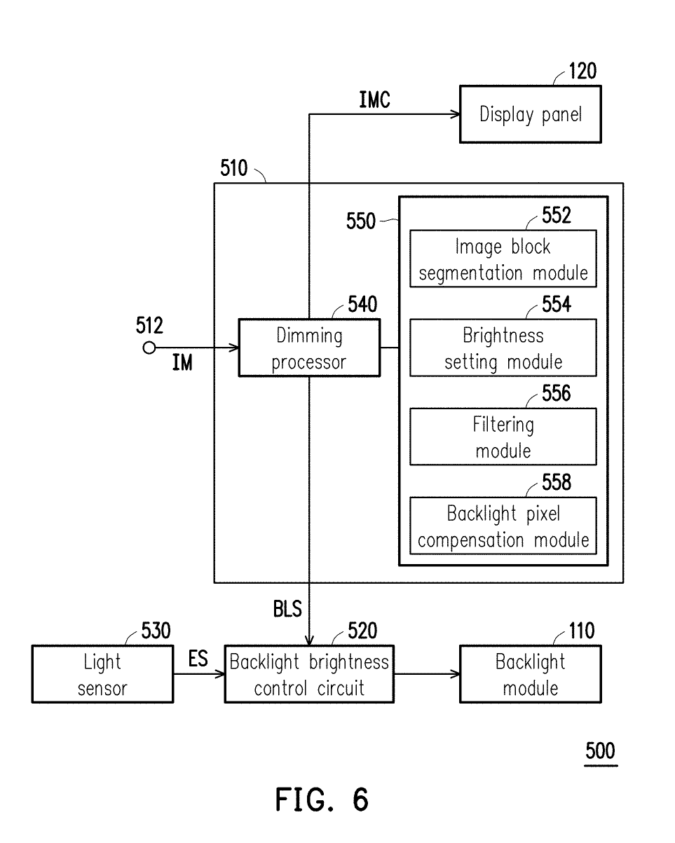

FIG. 6 is a schematic block view illustrating a projection unit according to an embodiment of the invention. With reference to FIG. 6, the projection unit 500 provided in the present embodiment may be the projection unit 100 provided in the previous embodiment. Specifically, the projection unit 500 has the backlight module with the optimized backlight brightness uniformity and can further perform a full array local dimming function, whereby the issues of power consumption and heat dissipation of the HUD may be effectively solved to a great extent, and the display quality may be improved.

The projection unit 500 includes the backlight module 110, the display panel 120, a dimming device 510, and a backlight brightness control circuit 520. The dimming device 510 includes a dimming processor 540 and a storage device 550.

The storage device 550 is, for instance, a random access memory (RAM), a read-only memory (ROM), a flash memory, a hard disk, other similar components, or a combination thereof; however, the disclosure is not limited thereto. Besides, the built-in modules including an image block segmentation module 552, a brightness setting module 554, a filtering module 556, and a backlight pixel compensation module 558 may be loaded and executed by the dimming processor 540.

The dimming processor 540 is, for instance, a central processing unit (CPU), a microprocessor, a digital signal processor (DSP), a programmable controller, an application specific integrated circuit (ASIC), other similar devices, or a combination thereof, but the disclosure is not limited hereto. The dimming processor 540 is connected to the display panel 120, the backlight brightness control circuit 520, and the storage device 550 and can load and execute the modules stored in the storage device 550, so as to perform the full array local dimming function described herein.

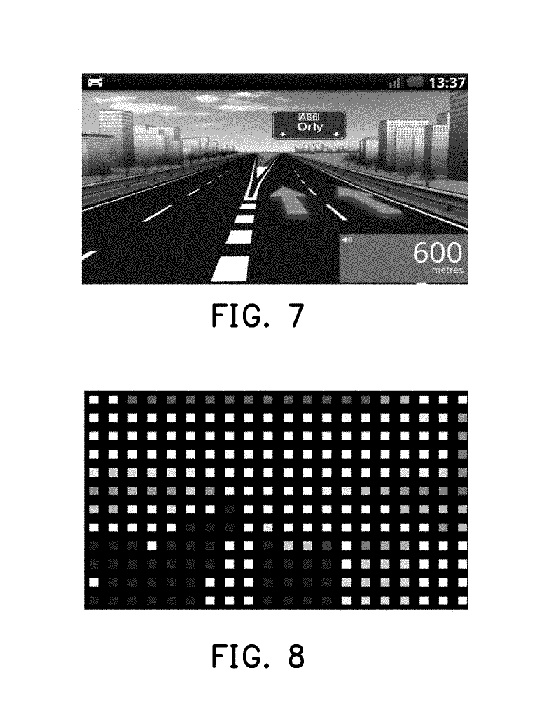

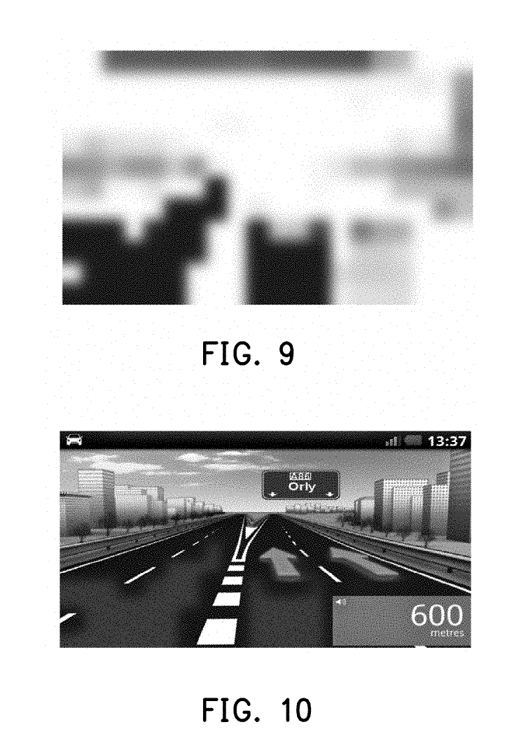

FIG. 7 is a schematic view illustrating image data according to an embodiment of the invention. FIG. 8 illustrates a distribution of backlight brightness setting values of a backlight module according to an embodiment of the invention. FIG. 9 illustrates a backlight illuminance distribution of a backlight module according to an embodiment of the invention. FIG. 10 is a schematic view illustrating compensation results of image data of a display panel according to an embodiment of the invention. The dimming device 510 receives the image data IM (the image shown in FIG. 7) from an image receiving end 512. After receiving the image data IM, the dimming processor 540 executes the image block segmentation module 552 to divide the image data IM into a plurality of image blocks according to locations or the number of the light-emitting sources 114 in the backlight module 110. In the present embodiment, each image block corresponds to one light-emitting source 114. After that, the dimming processor 540 executes the brightness setting module 554 and sets the required backlight brightness value according to the image feature of each image block. Specifically, an error-correction method may be applied in the present embodiment to set the brightness values of the light-emitting sources 114 corresponding to the image blocks according to the maximum and minimum brightness values of pixels of the image blocks. The dimming processor 540 then executes the filtering module 556 to perform spatial filter and temporal filter and eliminate grid noise and backlight flickers caused by local dimming and obtain the backlight brightness setting value BLS, e.g., the backlight brightness settings of the backlight module 110 (the light-emitting sources 114) as shown in FIG. 8. The dimming processor 540 then executes the backlight pixel compensation module 558 for compensating the pixels of the display panel 120 according to the backlight brightness setting value BLS and the original image pixel value of the image data IM, so as to obtain an image value compensation result IMC as shown by the image in FIG. 10. Finally, the dimming processor 540 provides the image value compensation result IMC to the display panel 120 for the display panel 120 to display an image, so that the image displayed on the local dimming condition and the image displayed according to the conventional backlight technique are consistent in terms of the perception of users through their eyes. In another aspect, the dimming processor 540 also provides the backlight brightness setting value BLS to the backlight brightness control circuit 520, which is coupled to the backlight module 110 for controlling the emitted light beam of the light-emitting sources 114, as shown by the backlight illuminance distribution of the backlight module 110 (the light-emitting sources 114) in FIG. 9. Therefore, the dimming device 510 may divide the to-be-displayed image data into a plurality of image blocks corresponding to the locations or the number of the light-emitting sources 114 and determine the light beams emitted from the corresponding light-emitting sources 114 according to the image features of the image blocks. The backlight brightness control circuit 520 may drive some of the light-emitting sources 114 according to the backlight brightness calculated by the dimming device 510, and therefore it is not necessary to always drive all of the light-emitting sources 114. When the image feature of one image block is the dark-state image, the backlight brightness control circuit 520 may reduce the brightness of the light beam emitted from the corresponding light-emitting source 114, or the corresponding light-emitting source 114 may not be driven, so as to solve the issue of dark-state light leakage. As such, the power consumption of the backlight module 110 may be significantly reduced, and the image contrast may be improved.

Besides, the projection unit 500 further includes a light sensor 530 configured to sense an ambient light. The light sensor 530 transmits the sensing result ES to the backlight brightness control circuit 520. Therefore, the backlight brightness control circuit 520 may automatically adjust the relative brightness value of the backlight module 110 according to not only the brightness of the display screen but also the intensity of external light. For instance, the range of the adjusted brightness of the backlight module 110 may be from 2500 nits to 15,000 nits. However, in some embodiments, the projection unit 500 may not include the light sensor 530. The disclosure is not limited thereto.

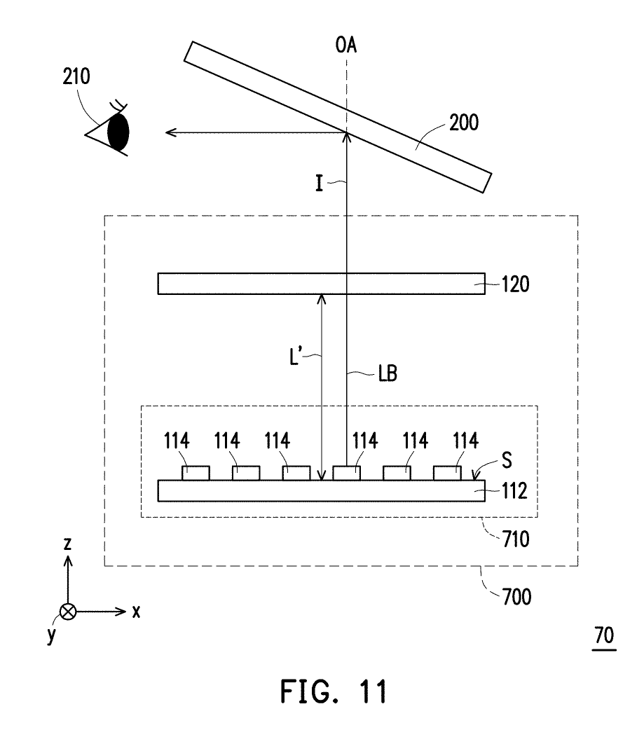

FIG. 11 is a schematic side view illustrating a HUD according to an embodiment of the invention. The HUD 70 includes a projection unit 700 and an optical sheet 200. The projection unit 700 includes a backlight module 710 and the display panel 120. The HUD 70 is similar to the HUD 30, while the difference therebetween lies in that the backlight module 710 of the HUD 70 does not include any diffusion sheet DP, which will be elaborated below.

The transparent device 116 in the HUD 10 may also be the display panel 120. Since the backlight module 710 does not include any diffusion sheet DP, the light beams emitted from the light-emitting sources 114 are directly incident to the display panel 120 to form the image beam I.

The light-emitting sources 114 are disposed on the surface S of the bottom plate 112 of the backlight module 710 and are periodically arranged in an array and provide the light beam LB to irradiate the display panel 120. The relationship of the arrangement pitches and the periodic patterns of the light-emitting sources 114 on the surface S and the distance L′ between the bottom plate 112 and the display panel 120 in the direction of the optical axis OA may be obtained by referring to the equations (4), (5), and (6), so that the brightness uniformity of the light beams projected on the display panel 120 by the light-emitting sources 114 is optimized. Persons skilled in the art may obtain the teachings and suggestions from the above embodiments, and thus no repetitive descriptions will be provided hereinafter.

To sum up, the backlight module provided in one or more embodiments of the invention at least includes the bottom plate and the light-emitting sources arranged in an array on the bottom plate. The light-emitting sources provide a light beam for irradiating the transparent device, and the transparent device is disposed above the bottom plate and the light-emitting sources. The distance between the bottom plate and the transparent device in the direction of the optical axis and the locations where the light-emitting sources are arranged on the bottom plate are designed to allow the light beam irradiating the transparent device to have the optimized brightness uniformity. Hence, the resulting backlight module is characterized by its simple structure and does not require additional power supply. The HUD provided in an embodiment of the invention includes the aforesaid backlight module, the display panel, and the optical sheet. Here, the transparent device may be the display panel or the diffusion sheet in the backlight module. The backlight module provides the light beam that penetrates the display panel to form the image beam, and the optical sheet reflects the image beam to the eyes of the user. The HUD provided in an embodiment of the invention may further perform the full array local dimming function. The to-be-displayed image is divided into a plurality of image blocks corresponding to the locations or the number of the light-emitting sources, and the light emission of the light-emitting sources is partially driven according to the image features of the image blocks. Besides, the relative brightness of the light beams from the light-emitting sources may be adjusted according to the ambient light. As such, the issues of power consumption and heat dissipation of the HUD may be effective solved to a great extent, and the display quality may be improved.

It will be apparent to those skilled in the art that various modifications and variations can be made to the structure described in the disclosure without departing from the scope or spirit of the disclosure. In view of the foregoing, it is intended that the disclosure cover modifications and variations provided they fall within the scope of the following claims and their equivalents.

What is claimed is:

1. A backlight module providing a light beam for irradiating a transparent device, the backlight module comprising:
a bottom plate disposed below the transparent device; and
a plurality of light-emitting sources arranged in an array on a surface of the bottom plate facing the transparent device, the plurality of light-emitting sources being configured to provide the light beam, wherein a distance L between the bottom plate and the transparent device in a direction of an optical axis is determined according to a total illuminance distribution of the light beam projected on the transparent device and locations where the plurality of light-emitting sources is arranged on the surface of the bottom plate.

2. The backlight module according to claim 1, wherein the distance L is determined according to a following equation:
$$\frac{{\partial }^{ 2}}{\partial {x}^{2}} {E}_{BLU} ( x , y , z ) = 0 , and \frac{{\partial }^{ 2}}{\partial {y}^{2}} {E}_{BLU} ( x , y , z ) = 0 ,$$
wherein E_{BLU}(x, y, z) is the total illuminance distribution, a geometric center of the plurality of light-emitting sources on the surface of the bottom plate or a geometric center of an arrangement unit of the plurality of light-emitting sources is a coordinate origin, z is a coordinate in a first direction, x is a coordinate in a second direction, and y is a coordinate in a third direction, wherein the first direction is perpendicular to the surface of the bottom plate, and the second direction and the third direction are parallel to the surface of the bottom plate and are perpendicular to each other.

3. The backlight module according to claim 1, the plurality of light-emitting sources on the surface of the bottom plate being arranged in a square array, a relationship between a minimum distance d between adjacent light-emitting sources of the plurality of light-emitting sources and the distance L between the bottom plate and the transparent device in the direction of the optical axis satisfies a following equation:
$$d = \frac{2 \cdot L}{{( m + 2 )}^{0.5}} ,$$
wherein m is a directive order of the plurality of light-emitting sources.

4. The backlight module according to claim 1, the plurality of light-emitting sources on the surface of the bottom plate being arranged in a square array, a relationship between a minimum distance d between adjacent light-emitting sources of the plurality of light-emitting sources and the distance between the bottom plate and the transparent device in the direction of the optical axis satisfies a following equation:
$$d = \frac{2}{\sqrt{3}} L ,$$
wherein each of the plurality of light-emitting sources is a Lambertian light source.

5. The backlight module according to claim 1, further comprising a diffusion sheet, the diffusion sheet being the transparent device.

6. The backlight module according to claim 1, wherein the transparent device is a display panel.

7. A head-up display comprising:
a display panel disposed on a transmission path of a light beam and configured to display an image, the light beam penetrating the display panel to form an image beam;
a backlight module configured to provide the light beam to irradiate the display panel and comprising:
a bottom plate disposed below the display panel;
a diffusion sheet disposed on the transmission path of the light beam and located between the bottom plate and the display panel; and
a plurality of light-emitting sources arranged in an array on a surface of the bottom plate and configured to emit the light beam, wherein a distance L between the bottom plate and the diffusion sheet in a direction of an optical axis is determined according to a total illuminance distribution of the light beam projected on the diffusion sheet and locations where the plurality of light-emitting sources is arranged on the surface of the bottom plate; and
an optical sheet disposed on a transmission path of the image beam, the image beam being reflected by the optical sheet to a user's eyes.

8. The head-up display according to claim 7, wherein the distance L is determined according to a following equation:
$$\frac{{\partial }^{ 2}}{\partial {x}^{2}} {E}_{BLU} ( x , y , z ) = 0 , and \frac{{\partial }^{ 2}}{\partial {y}^{2}} {E}_{BLU} ( x , y , z ) = 0 ,$$
wherein E_{BLU}(x, y, z) is the total illuminance distribution, a geometric center of the plurality of light-emitting sources on the surface of the bottom plate or a geometric center of an arrangement unit of the plurality of light-emitting sources is a coordinate origin, z is a coordinate in a first direction, x is a coordinate in a second direction, and y is a coordinate in a third direction, wherein the first direction is perpendicular to the surface of the bottom plate, and the second direction and the third direction are parallel to the surface of the bottom plate and are perpendicular to each other.

9. The head-up display according to claim 7, the plurality of light-emitting sources being arranged in a square array, a relationship between a minimum distance d between adjacent light-emitting sources of the plurality of light-emitting sources and the distance L between the bottom plate and the diffusion sheet in the direction of the optical axis satisfies a following equation:
$$d = \frac{2 \cdot L}{{( m + 2 )}^{0.5}} ,$$
wherein m is a directive order of the plurality of light-emitting sources.

10. The head-up display according to claim 7, the plurality of light-emitting sources being arranged in a square array, a relationship between a minimum distance d between adjacent light-emitting sources of the plurality of light-emitting sources and the distance L between the bottom plate and the diffusion sheet in the direction of the optical axis satisfies a following equation:
$$d = \frac{2}{\sqrt{3}} L ,$$
wherein each of the plurality of light-emitting sources is a Lambertian light source.

11. The head-up display according to claim 7, further comprising:
a dimming device configured to receive image data, divide the image data into a plurality of image blocks corresponding to locations or the number of the plurality of light-emitting sources, and generate a backlight brightness setting value of the plurality of light-emitting sources according to an image feature of each of the plurality of image blocks; and
a backlight brightness control circuit coupled to the plurality of light-emitting sources and the dimming device, the backlight brightness control circuit receiving the backlight brightness setting value from the dimming device for respectively adjusting light intensity of each of the plurality of light-emitting sources according to the backlight brightness setting value.

12. The head-up display according to claim 11, wherein the dimming device determines the backlight brightness setting value of a corresponding light-emitting source of the plurality of light-emitting sources according to a brightness value of pixels in each of the plurality of image blocks.

13. The head-up display according to claim 11, further comprising:
a light sensor configured to detect environment and generate an ambient light feature, the light sensor being coupled to the backlight brightness control circuit,
wherein the backlight brightness control circuit adjusts the light intensity of each of the plurality of light-emitting devices according to the ambient light feature generated by the light sensor.

14. The head-up display according to claim 11, wherein a material of the optical sheet comprises glass, a front windshield, optical film glass, or metalized film glass.

15. A head-up display comprising:
a display panel disposed on a transmission path of a light beam and configured to display an image, the light beam penetrating the display panel to form an image beam; and
a backlight module configured to provide the light beam to irradiate the display panel and comprising:
a bottom plate disposed below the display panel; and
a plurality of light-emitting sources arranged in an array on a surface of the bottom plate and configured to emit the light beam, wherein a distance between the bottom plate and the display panel in a direction of an optical axis is determined according to a total illuminance distribution of the light beam projected on the display panel and locations where the plurality of light-emitting sources is arranged on the surface of the bottom plate; and
an optical sheet disposed on a transmission path of the image beam, the image beam being reflected by the optical sheet to a user's eyes.
